(19) United States
(12) Patent Application Publication
(10) Pub. No.: US 2021/0133672 A1
(43) Pub. Date: May 6, 2021

(54) SMART STORAGE EQUIPMENT FOR SMART LOGTISTICS SYSTEM AND SMART LOGISTICS METHOD USING THE SAME

(71) Applicant: Ming-Hsien Chiu, New Taipei City (TW)

(72) Inventors: Ming-Hsien Chiu, New Taipei City (TW); Yu-Wen Han, Taoyuan City (TW)

(21) Appl. No.: 16/920,660

(22) Filed: Jul. 4, 2020

(30) Foreign Application Priority Data
Oct. 31, 2019 (TW) 108214366

(51) Int. Cl. G06Q 10/08; G07C 9/00

(52) U.S. Cl. CPC G06Q 10/0832; G06Q 50/28; G07C 9/00309; G06Q 10/0835

(57) ABSTRACT

A smart storage equipment for smart logistics system and a smart logistics method using the same are provided. The smart storage equipment has a base device and at least one logistic container, and can be installed on a vehicle. The logistic container is loaded with goods and accommodated in a container-storage structure of the base device, wherein the container-storage structure reads an identification of the logistic container and locks the logistic container therein. Furthermore, according to a container-release data from a server, a container control unit of the base device controls the corresponding container-storage structure to unlock the logistic container.

### REFERENCE TO RELATED APPLICATIONS

This non-provisional application claims priority claim under 35 U.S.C. § 119(a) on Taiwan Patent Application No. 108214366 filed on Oct. 31, 2019, and the entire contents of which are incorporated herein by reference.

### FIELD

The present disclosure relates to a smart storage equipment for smart logistics system and a smart logistics method using the smart storage equipment, more particularly, to a smart storage equipment for smart logistics system and a smart logistics method using the smart storage equipment that ensures the integrity of goods by transporting the goods from its origin at vendor or seller's place to its destination in an individually-held arrangement on a storage structure of a vehicle without being unloaded during the transporting process.

### BACKGROUND

Along with the interne contents and services being more and more associated to our everyday living, online shopping has also become an activity that is inseparable from our daily lives. Online shopping platforms, models and deliveries of different types are prospering, and besides the common delivery of goods, there are deliveries that specialize in fresh or perishable ingredients and cooked foods/hot meals.

Currently, deliveries of goods on land usually take up two vehicle forms: motorcycles or trucks, and in general, the delivery vehicle is selected based on the size and quantity of goods to be delivered as well as the delivery distance. Regardless of which vehicle is used, the goods are generally picked up by a delivery person and placed in a box or a locker on the delivery vehicle in a random order, or sometimes in a specific order pending on their destinations. Once the delivery person arrives at their destination, the goods are taken out. However, as the delivery person picks up the goods and takes out the goods along the way, not only is there a possibility that wrong goods are taken out, the goods could also be damaged from being moved around when the delivery person is looking for other goods.

Moreover, most of the boxes or lockers on the delivery vehicles are purely a single space for accommodating all goods, and occasionally there are shelves in the boxes or lockers to place the goods in different levels. But, the shelves are not designed to hold the goods in place, and so the goods may move or bump into one another due to the road condition during transportation and are therefore damaged. In addition, it would be hard to know whether the goods have been tempered or stolen by the delivery person, and so when the defected goods is delivered to the buyer or when the buyer does not receive the goods, disputes on the sale of the goods arise.

### SUMMARY

Therefore, to solve the aforementioned issues, the present disclosure provides a smart storage equipment for smart logistics system and a smart logistics method using the smart storage equipment. The smart storage equipment includes a base device and at least one logistic container, wherein the logistic container is loaded with goods and accommodated in a container-storage structure of the base device, and the smart logistics method obtains an identification information of the logistic container and locks the logistic container therein. Moreover, the base device includes a container control unit, where the smart logistics method unlocks the locking between the logistic container and the container-storage structure through the container control unit according to a container-release data in or from a server. The smart storage equipment for smart logistics system and the smart logistics method using the smart storage equipment ensure the integrity of the goods by transporting the goods from the vendor's (seller's) place to the destination in an individually-held arrangement on the storage structure of the vehicle during the transportation process and by only permitting the goods to be unloaded at its destination point. Furthermore, each logistic container is individually locked to a specific container-storage structure in the base device and the unlocking between them is controlled based on the container-release data, and thus the possibilities of the delivery person taking the wrong goods or the goods being damaged from moving or bumping are reduced.

An object of the present disclosure is to provide a smart storage equipment for smart logistics system that includes a base device and at least one logistic container. The base device includes a base, a communication unit and a container control unit, wherein the base has a plurality of container-storage structures and the communication unit and the container control unit are disposed in the base. Each of the plurality of container-storage structures has disposed therein a container lock and an identification control unit. The identification control unit is electrically or communicatively connected to the container control unit, the container control unit is communicatively connected to the communication unit, and the communication unit is communicatively connected to a server. The logistic container includes a container body that has an identification information and further has disposed therein a base lock corresponding to the container lock. When the logistic container is placed in the container-storage structure, the identification control unit reads the identification information of the logistic container and enforces a locking between the container lock and the base lock. When the logistic container is locked in the container-storage structure, the container control unit controls an unlocking between the container lock and the base lock according to a container-release data in or from the server.

Another object of the present disclosure is to provide a smart logistics system that includes a vehicle, the aforementioned smart storage equipment disposed on the vehicle, and a server.

Another object of the present disclosure is to provide a smart logistics method using smart storage equipment that has the following steps. First, a smart storage equipment having a base device and at least one logistic container is provided, wherein the base device includes a base with a plurality of container-storage structures and, a communication unit and a container control unit disposed in the base. Each of the plurality of container-storage structures has disposed therein a container lock and an identification control unit. The container control unit is communicatively or electrically connected to the identification control unit and communicatively connected to the communication unit, and the communication unit is communicatively connected to a server. The logistic container includes a container body that has an identification information and includes a base lock corresponding to the container lock disposed therein. Second, the logistic container is placed in the container-storage structure. Third, the identification control unit reads the identification information of the logistic container and enforces a locking between the container lock and the base lock. Last, the container control unit controls an unlocking between the container lock and the base lock according to a container-release data in or from the server.

Preferably, the container-release data includes information of logistic containers that need to be unlocked. Based on the container-release data, the container control unit generates and sends a release signal to the identification control unit of the container-storage structure containing the logistic container that needs to be unlocked so as to control the identification control unit to unlock the locking between the container lock and the base lock.

Preferably, the container control unit includes a control button. The release signal is generated when the control button is touched or pressed by a delivery person, and the logistic container corresponding to the container-release data is unlocked so that the delivery person can take the unlocked logistic container out of the base device.

Preferably, the base further includes at least one storage module for disposing the plurality of container-storage structures. The storage module is disposed on the base and is fixed, rotatable or slidable relative to the base.

Preferably, the smart storage equipment further includes a carrier mechanism movably disposed around a periphery of the base and facing a side of the container-storage structure that stores the logistic container. The carrier mechanism is electrically or communicatively connected to the container control unit. The container control unit controls the carrier mechanism to take the unlocked logistic container according to the container-release data.

Preferably, the carrier mechanism includes a box, and the carrier mechanism takes and puts the unlocked logistic container in the box for a delivery person to take. When a new logistic container is put in the box by the delivery person, the container control unit controls the carrier mechanism to take and place the new logistic container in an unoccupied container-storage structure of the base.

Preferably, the container control unit controls the carrier mechanism to place the unlocked logistic container in a stationary storage facility according to a container-delivery data in or from the server.

Preferably, the container control unit controls the carrier mechanism to take a new logistic container from a stationary storage facility and place the new logistic container in an unoccupied container-storage structure of the base.

Preferably, the container-storage structure further includes an indicator electrically connected to the identification control unit. The identification control unit activates the indicator based on the release signal so that a delivery person can pinpoint the unlocked logistic container.

Preferably, the vehicle is a motorcycle, an automobile, a truck, an unmanned flying vehicle, a watercraft, or an airplane.

Preferably, the carrier mechanism includes a smart positioning module. When the vehicle stops by a stationary storage facility, according to a container-delivery data in or from the server, the container control unit drives the smart positioning module of the carrier mechanism to decipher the container-delivery data so as to know a location of a new logistic container in the stationary storage facility, and the container control unit controls the carrier mechanism to take the new logistic container from the stationary storage facility.

Preferably, the vehicle includes a first electronic device signally connected to the server. When the vehicle stops by a stationary storage facility, the container control unit controls the carrier mechanism to place the unlocked logistic container in the stationary storage facility according to a container-delivery data in or from the server and sends a completion signal to the server through the communication unit after the unlocked logistic container is placed in the stationary storage facility and the server sends a completion notification to the first electronic device.

As stated above, the present disclosure provides a smart storage equipment for smart logistics system and a smart logistics method using smart storage equipment that reduce the mistaking of goods by the delivery person of the logistic operator during pick-up and drop-off/delivery, and through automated management of logistic containers, the time spent organizing and looking for goods is saved and so the efficiency and cost saving in logistics are improved. Further, the locking between the container-storage structure and the logistic container reduces the chance of the goods in the logistic container being damaged due to movements and bumps and the possibility of the goods being stolen or tempered by the delivery person. Thus, the smart storage equipment and the smart logistics method of the present disclosure are advantageous in markets with logistics distribution needs, such as commercial stores, food industry, and logistic operators.

### BRIEF DESCRIPTION OF THE DRAWINGS

The structure as well as preferred modes of use, further objects, and advantages of this present disclosure will be best understood by referring to the following detailed description of some illustrative embodiments in conjunction with the accompanying drawings, in which:

FIG. 1 is a side schematic view of a smart storage equipment for smart logistics system according to an embodiment of the present disclosure.

FIG. 2A is a schematic diagram of a logistic container of a smart storage equipment for smart logistics system according to an embodiment of the present disclosure.

FIG. 2B is a rear schematic view of a logistic container of a smart storage equipment for smart logistics system according to an embodiment of the present disclosure.

FIG. 3 is a schematic diagram illustrating signal connections of a smart logistics system according to an embodiment of the present disclosure.

FIG. 4 is a flow chart illustrating an unlocking process of a smart storage equipment in a smart logistics method according to an embodiment of the present disclosure.

FIG. 5 is a top schematic view of a smart storage equipment for smart logistics system according to first embodiment of the present disclosure.

FIG. 6 is a flow chart illustrating goods pick-up and drop-off process in a smart logistics method according to first embodiment of the present disclosure.

FIG. 7 is a side schematic view of a smart storage equipment for smart logistics system according to second embodiment of the present disclosure.

FIG. 8 is a top schematic view of a smart storage equipment for smart logistics system according to second embodiment of the present disclosure.

FIG. 9 is a schematic diagram illustrating signal connections of a smart logistics system according to second embodiment of the present disclosure.

FIG. 10 is a schematic diagram of a box of a smart logistics system according to second embodiment of the present disclosure.

FIG. 11 is a flow chart illustrating goods pick-up and drop-off process in a smart logistics method according to second embodiment of the present disclosure.

FIG. 12 is a side schematic view of a smart storage equipment for smart logistics system according to third embodiment of the present disclosure.

FIG. 13 is a top schematic view of a smart storage equipment for smart logistics system according to third embodiment of the present disclosure.

FIG. 14 is a flow chart illustrating goods pick-up and drop-off process in a smart logistics method according to third embodiment of the present disclosure.

### DETAILED DESCRIPTION OF THE PREFERRED EMBODIMENTS

The present disclosure provides a smart storage equipment for smart logistics system and a smart logistics method using the smart storage equipment, wherein the smart storage equipment includes a base device and at least one logistic container. When a consumer ordered goods like articles or foods, a vendor, like a store or a business, puts the ordered goods in the logistic container of the smart storage equipment and a delivery person, like that of a logistic operator, places the logistic container in a container-storage structure of the base device to deliver the logistic container to a stationary storage facility designated by the consumer. Once the logistic container is placed in the container-storage structure, the container-storage structure reads an identification information of the logistic container and enforces an locking action so that the logistic container is locked in the container-storage structure during transportation. Subsequently, when the delivery person arrives at the stationary storage facility, a server sends a container-release data to the base device and according to the container-release data, the base device releases the locking of the logistic container whose destination is the current stationary storage facility, so that the delivery person is able to remove the logistic container from the container-storage structure and place it in the stationary storage facility. The present disclosure is described using manual, semi-automatic, and automatic modes for delivery and distribution of goods as illustrations, but the present disclosure is not limited by the types of delivery mode in logistics. The smart storage equipment for smart logistics system saves the extra cost that the vendor may incur due to damaged goods. In addition, since the smart storage equipment has multiple container-storage structures and logistic containers, and each logistic container has its own and unique identification information and its individual accommodating space, the goods are assured to be unloaded at the right location for the consumer to pick-up. Therefore, the smart storage equipment for smart logistics system and the smart logistics method using the smart storage equipment as described by the present disclosure have the potential to replace the current logistic box or locker on delivery vehicles, and to eliminate the time spent by the delivery person taking out and unloading the goods during delivery.

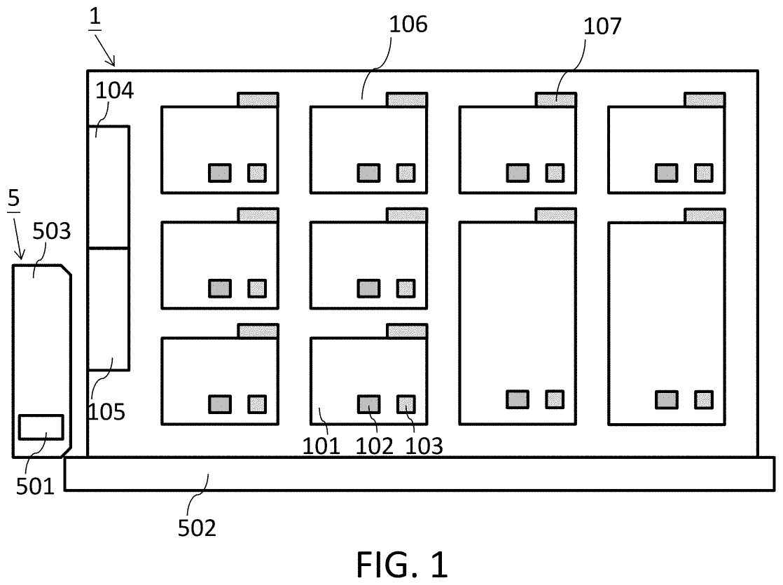

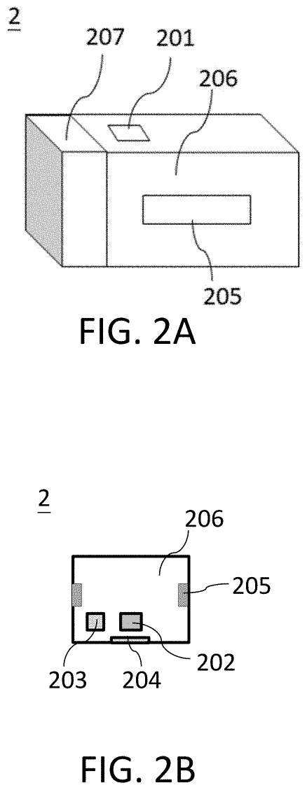

FIG. 1, FIG. 2A and FIG. 2B are respectively a schematic diagram of a smart storage container, a schematic diagram of a logistic container of a smart storage equipment, and a rear view of the logistic container in FIG. 2A viewing from the right side to the left side according to an embodiment of the present disclosure. As shown in FIG. 1, the base device 1 of the smart storage equipment includes a base 106 and a plurality of container-storage structures 101, wherein a communication unit 104 and a container control unit 105 are disposed in the base 106, and each of the container-storage structures 101 has a container lock 102, an identification control unit 103, and an indicator 107 disposed therein. The indicator 107 is disposed on an external side of the container-storage structure 101 such that a delivery person can easily pinpoint the indicator 107 when the indicator 107 is activated. As shown in FIG. 2A and FIG. 2B, the logistic container 2 of the smart storage equipment includes a container body 206, a base lock 202, a transceiver control unit 203 and a barcode 201 containing identification information. The barcode 201 is, for example, two-dimensional barcode or quick response code (QR code), and is not an essential element of the present disclosure as the identification information can be read by near-field communication or other methods. The logistic container 2 has an accommodation space therein and an openable lid 207, wherein the vendor, like business or store, can place the goods, like merchandise or food, that are ordered by the consumer in the logistic container 2. The container body 206 has a clamping structure 205 and a rotating structure 204 for the taking and removing of the logistic container 2. The clamping structure 205 and the rotating structure 204 are, for example, recesses that are disposed on the two sides and bottom of the container body 206, but the present disclosure is not limited thereby. When the logistic container 2 is placed in the container-storage structure 101 of the base 106, the identification control unit 103 of the container-storage structure 101 detects the barcode 201 of the logistic container 201, reads the identification information, and then controls the container lock 102 of the container-storage structure 101 to lock correspondingly with the base lock 202 of the logistic container 202. One of the container lock 102 of the container-storage structure 101 and the base lock 202 of the logistic container 2 is metal and the other one is electromagnet, but the present disclosure is not limited thereby, they can also be lock structures that correspond to each other and one or both of them can be driven by electrical power to execute locking and unlocking. In other embodiments, the identification information of the logistic container 2 is sent by the transceiver control unit 203 of the logistic container to the identification control unit 103 of the container-storage structure 101, but the present disclosure is not limited thereby.

FIG. 1 further illustrated a vehicle 5 carrying the smart storage equipment for transporting the logistic container 2 from its place of origin to its destination. The vehicle 5 is a motorcycle, an automobile, a truck, an unmanned flying vehicle, a watercraft, an airplane, or any transportation tool capable of transporting goods, the present disclosure is not limited thereby. The vehicle 5 includes a first electronic device 501 and a carrying portion 502, wherein the first electronic device 501 is disposed or located in a driver's compartment 503 on the vehicle 5, and the base device 1 of the smart storage equipment is disposed on the carrying portion 502. The carrying portion 502 is, for example, the stack frame behind the backseat of the motorcycle, or the container on or the platform of the truck.

In one embodiment, the logistic container 2 is a logistic container with thermal insulation to ensure the freshness of the goods in the logistic container, wherein the thermal insulation functions to maintain temperature so as to keep the goods hot and/or cold, and the present disclosure is not limited by the logistic container 2 having the thermal insulation capability or not. Moreover, a replaceable or chargeable battery is disposed in the logistic container 2 to obtain electrical power, or no battery is disposed in the logistic container 2 but instead an induction circuit that is capable of conducting wireless detection at near-field and obtains electrical power. The present disclosure does not limit the method which the logistic container 2 uses to obtain electrical power.

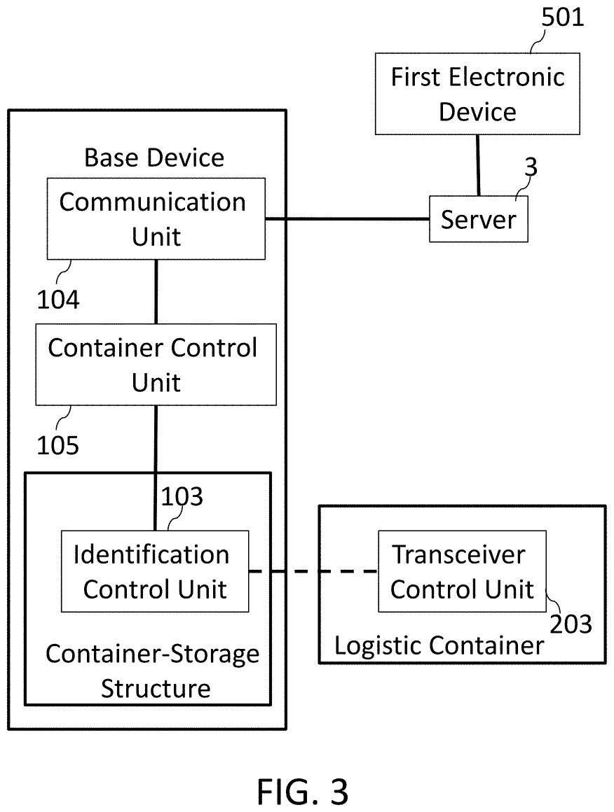

Referring to FIG. 3, a smart logistics system includes the smart storage equipment, which has the base device 1 and the logistic container 2, and a server 3. The communication unit 104 of the base device 1 is communicatively connected to the server 3 and is communicatively connected to the container control unit 105, and the identification control unit 103 of the base device 1 is communicatively or electrically connected to the container control unit 105 and is communicatively connected to the transceiver control unit 203 of the logistic container 2. When a delivery person uses the first electronic device 501 to access the smart logistics system, the first electronic device 501 is communicatively connected to the server 3.

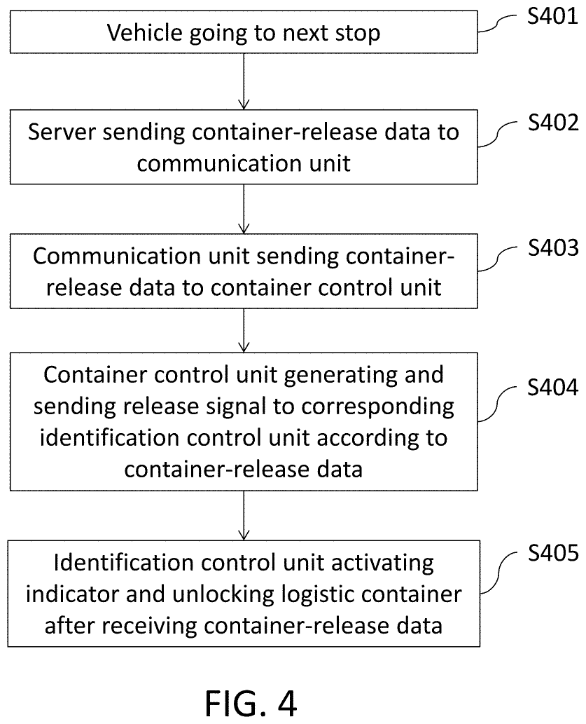

In the aforementioned embodiment, the hardware of the smart storage equipment and its connection to the server are described, and a smart logistics method for using the smart storage equipment and details about the smart logistics system are described herein. FIG. 4 is a flow chart illustrating the steps of unlocking the smart storage equipment in the smart logistics method according to an embodiment of the present disclosure. As shown in step S401, the vehicle carrying the base device and the logistic container is driven by the delivery person on its way to a stop, for example but not limited to, a vendor or a stationary storage facility. When the vehicle is in motion, the logistic container is placed and locked in the container-storage structure of the base device to ensure that the logistic container does not move during the transportation so as to reduce the chance of the goods being bumped or damaged. On the way to the stop or upon arriving at the stop, as shown in step S402, the server sends a container-release data to the communication unit of the base device, wherein the container-release data includes information of logistic containers whose designation is the upcoming stop or the current stop and need to be unlocked. The container-release data has integrated therein information of all of the logistic containers that need to be unlocked and released so the server only needs to send the container-release data once, or the container-release data only has information of an individual logistic container that needs to be unlocked and released so the server may need to send the container-release data multiple times. The present disclosure does not limit the format/content/quantity of the container-release data or the number of times which the server sends the container-release data. Next, step S403 is the communication unit receiving the container-release data and sending it to the container control unit of the base device. In step S404, based on the container-release data, the container control unit generates and sends a release signal to the identification control unit of corresponding container-storage structure, wherein the corresponding container-storage structure is the container-storage structure that stores/contains the logistic container whose designation is next stop or the upcoming stop or the current stop. Through the container-release data, the container control unit is able to identify the corresponding container-storage structure because the container-release data includes, for example but not limited to, information of the container-storage structure that stores/contains the logistic container. In other embodiments, the container control unit sends the release signal by comparing the identification information of the logistic container that needs to be unlocked provided in the container-release data to the identification information of the logistic container in the container-storage structure, but the present disclosure is not limited thereby. After the identification control unit receives the release signal, as shown in step S405, the identification control unit activates the indicator of the corresponding container-storage structure and releases the locking between the container lock of the container-storage structure and the base lock of the logistic container such that the logistic container is unlocked. At this time, the logistic container stored in the container-storage structure with activated indicator is unlocked, in other words, the activated indicator marks the logistic container that is unlocked and thus the mistaking of goods is eliminated.

When the delivery person drives the vehicle and arrives at the stop, there are three ways to unload the logistic container from the vehicle: manually, semi-automatically, or automatically, and their logistic container pick-up/drop-off processes and the infrastructures of the smart storage equipment used to pick-up/drop-off the logistic container will be described respectively as follow.

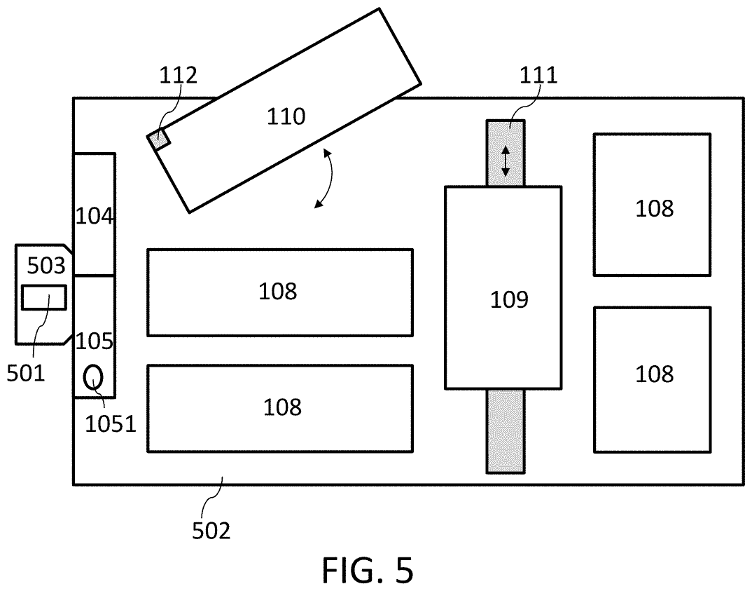

FIG. 5 is a top schematic view of a smart storage equipment according to first embodiment of the present disclosure that is used for unloading goods manually. The base 106 of the base device 1 includes a plurality of storage modules 108, 109, 110, in which the plurality of container-storage structures 101 are disposed. The storage module 108 is a fixed-type module that is fixed to the base 106 and cannot move. The storage module 109 is a sliding-type module disposed on a rail 111 of the base 106 or of the carrying portion 502 such that the storage module 109 can slide relative to the base 106. The storage module 110 is a rotating-type module that has a shaft 112 disposed on the base 106 or on the carrying portion 502 such that the storage module 110 can rotate relative to the base 106. The combination of different types of storage modules 108, 109, 110 increases the quantity of container-storage structures 101 on a vehicle and is convenient for the delivery person to find the container-storage structure 101 and take out the logistic container 2.

Moreover, the container control unit 105 has a control button 1051 disposed therein for controlling the transmitting of the release signal, which can be used by the delivery person to control when to unlock the logistic containers.

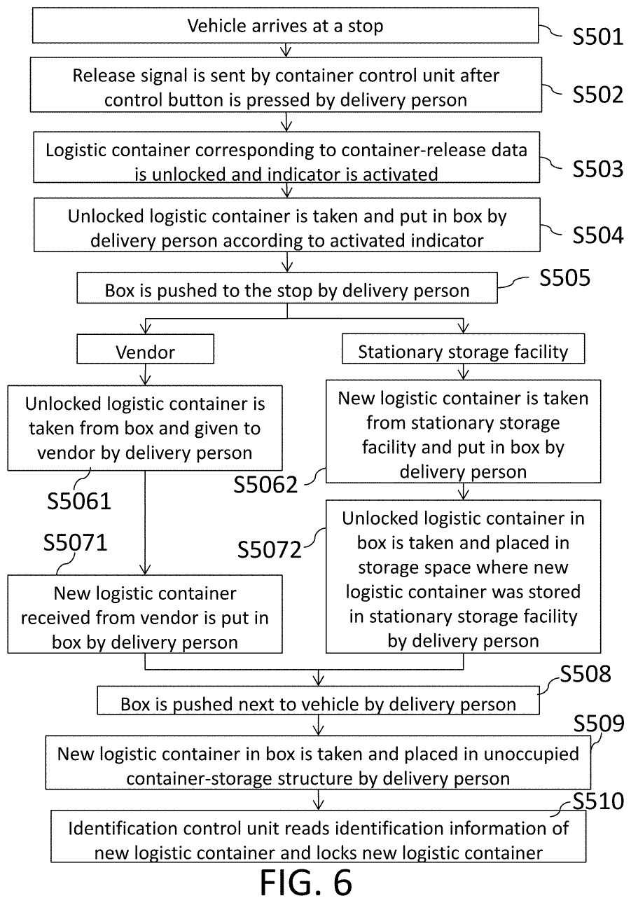

Referring to FIG. 6, which is a pick-up and drop-off process in a smart logistics method according to first embodiment of the present disclosure, the delivery person drives the vehicle and arrives at the stop in step S501, wherein the stop is a vendor or a stationary storage facility, the present disclosure is not limited thereby. In step S502, the control button of the container control unit is pressed or touched by the delivery person and the container control unit generates and sends a release signal to the identification control unit of the corresponding container-storage structure. Next, step S503 is the identification control unit unlocking the corresponding logistic container and activating the indicator of the corresponding container-storage structure after receiving the release signal. The identification and unlocking process of the corresponding container-storage structure are as aforementioned with reference to FIG. 4 and therefore will not be described herein. In step S504, through the activated indicator, the delivery person knows precisely which logistic container to take and puts the unlocked logistic container in a box, wherein the box is any case with a space that can temporarily house the logistic container and serves as a transfer station for the unloaded logistic container. Then, the delivery person pushes the box to the stop in step S505 after taking out all of the logistic containers whose designation is the current stop.

When the stop is a vendor, the delivery person gives the unlocked logistic container to the vendor as shown in step S5061, and if the vendor gives a new logistic container to the delivery person, the delivery person puts the newly received logistic container in the box in step S5062. In general, the logistic container given to the vendor by the delivery person, namely the unlocked logistic container, is empty and the logistic container given to the delivery person by the vendor, namely the new logistic container, is loaded with goods, but the present disclosure is not limited thereby.

When the stop is a stationary storage facility, if the stationary storage facility is full, in other words, there is no storage space for placing more logistic container, the delivery person takes a new logistic container from the stationary storage facility and puts it in the box as shown in step S5062. Then, in step S5072, the delivery person places the unlocked logistic container from the box into where the new logistic container was stored in the stationary storage facility. In general, the logistic container taken by the delivery person from the stationary storage facility, namely the new logistic container, is empty, and the logistic container placed into the stationary storage facility by the delivery person, namely the unlocked logistic container, is loaded with goods, but the present disclosure is not limited thereby. Further, if the stationary storage facility is not full, then step S5062 is optional and can be skipped, and the delivery person just place the unlocked logistic container from the box into any storage space that is unoccupied by other logistic container in the stationary storage facility.

After the delivery person distributed all of the unlocked logistic containers in the box, the delivery person pushes the box back to the vehicle in step S508 and subsequently in step S509, takes out the new logistic container in the box and places it in any one of the container-storage structures that is unoccupied by other logistic container in the base device. As shown in step S510, when the new logistic container is placed in the container-storage structure, the identification control unit of the container-storage structure reads the identification information of the new logistic container and locks the new logistic container in the container-storage structure. Specifically, after the identification control unit reads the identification information of the new logistic container, the identification control unit controls the container lock of the container-storage structure and the base lock of the logistic container to lock correspondingly. In general, at each stop, the unlocked logistic containers that have arrived at their destination are unloaded from the vehicle and new logistic containers are loaded onto the vehicle, but it could be that only unloading or loading of logistic containers occurs at the stop, the present disclosure is not limited thereto. For example, there may be no new logistic container in the box to be loaded onto the vehicle at certain stops.

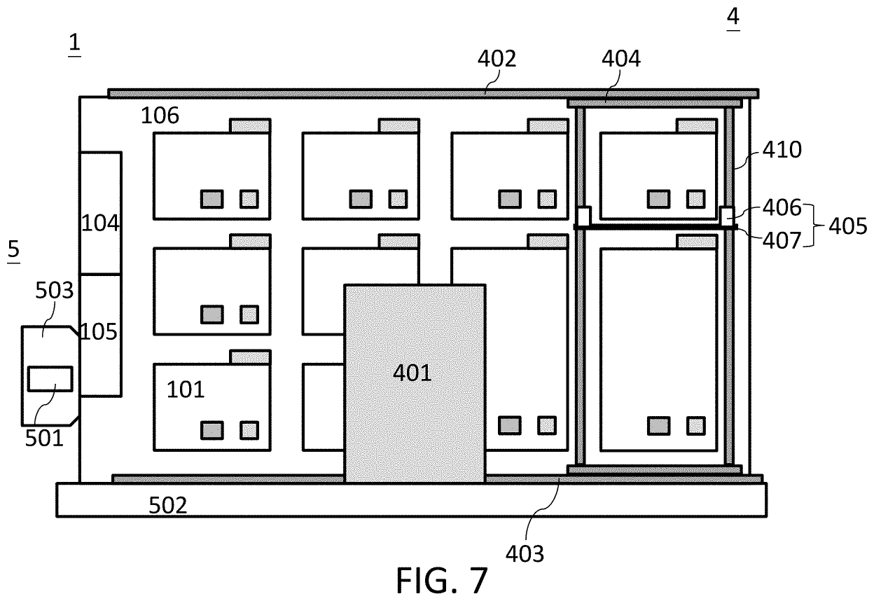

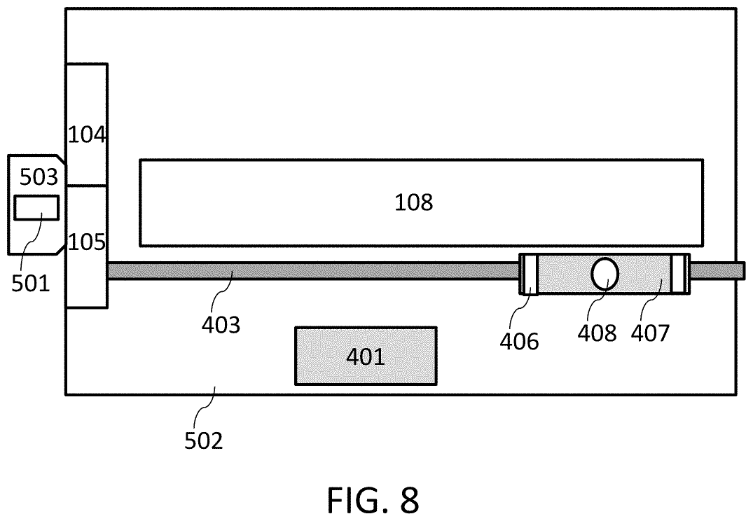

FIG. 7 and FIG. 8 are respectively a side view and a top view of a smart storage equipment for smart logistics system according to second embodiment of the present disclosure that is used for unloading goods semi-automatically. The smart storage equipment includes a carrier mechanism 4 movably disposed around a periphery of the base 106 in the base device 101 and facing a side of the container-storage structure 101 that stores the logistic container 2 in the storage module 108. The carrier mechanism 4 includes an upper rail 402 and a lower rail 403 respectively disposed on the top and the bottom of the base 106 and a movable mechanism 410 slidably disposed between the upper rail 402 and the lower rail 403, wherein the movable mechanism 410 is capable of moving horizontally along the base 106 through the upper rail 402 and the lower rail 403. The movable mechanism 410 is disposed with a movable body 404 and a clamping module 405. The movable body 404 is a rectangular frame having a top bracket, a bottom bracket, a left-side bracket and a right-side bracket, wherein the top bracket and the bottom bracket are respectively disposed slidably on the upper rail 402 and the lower rail 403, and the left-side bracket and the right-side bracket support the clamping module 405 to move vertically in the movable body 404. The clamping module 405 includes an elevator unit 407 movable up and down in the movable body 404 and a clamping unit 406 disposed in the elevator unit 407, wherein the clamping unit 406 is capable of performing clamping, pushing, rotating and other moves to take the logistic container 2 out of the container-storage structure 101 and place it in the elevator unit 407. The present disclosure does not limit the structure and composition of the carrier mechanism, any apparatus capable of horizontal and/or vertical displacements and capable of taking or placing the logistic container in the base device can serve as the carrier mechanism.

The carrier mechanism 401 further includes a box 401 detachably disposed on the carrying portion 502 of the vehicle 5, wherein the carrier mechanism 410 can perform the taking and the placing of the logistic container 2 between the box 401 and the container-storage structure 101 both ways.

In one embodiment, the clamping unit 406 includes a rotating unit 408 disposed in the elevator unit 407 for rotating the logistic container 2 to a correct direction to be placed into the box 401 or the container-storage structure 101.

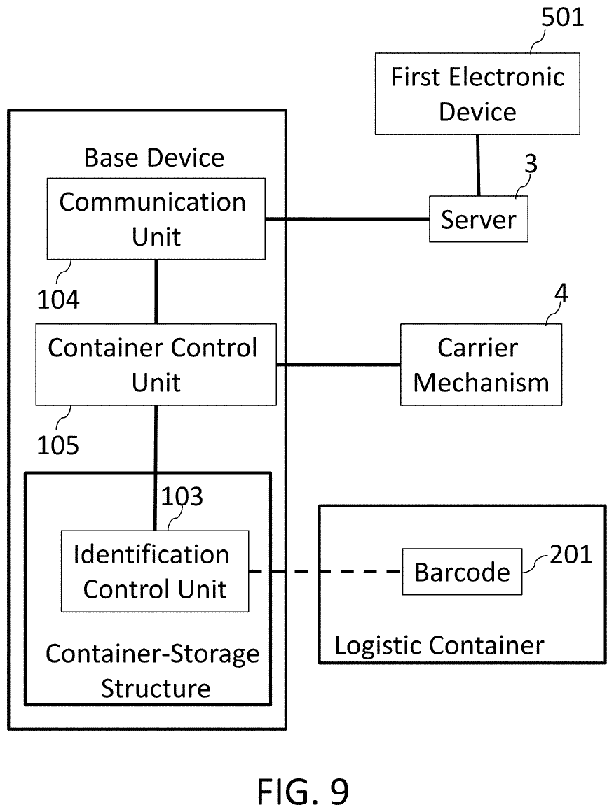

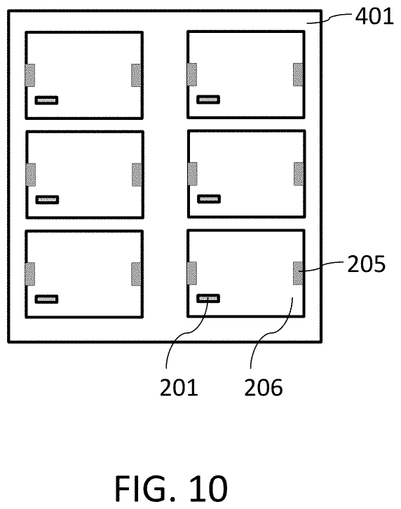

As shown in FIG. 9, the carrier mechanism 4 is electrically or communicatively connected to the container control unit 105 of the base device 1. The container-control unit 105 controls the movable mechanism 410 of the carrier mechanism 4 to move to the corresponding container-storage structure 101 according to the container-release data received from the server or according to the activated indicator, and controls the clamping module 405 to take out the unlocked logistic container 2 before moving the movable mechanism 410 next to the box 401 and putting the logistic container 2 into the box 401. The structure of the box 401 shown in FIG. 10 has a plurality of accommodating spaces for placing the logistic container 2, but the present disclosure does not limit the structure and composition of the box 401.

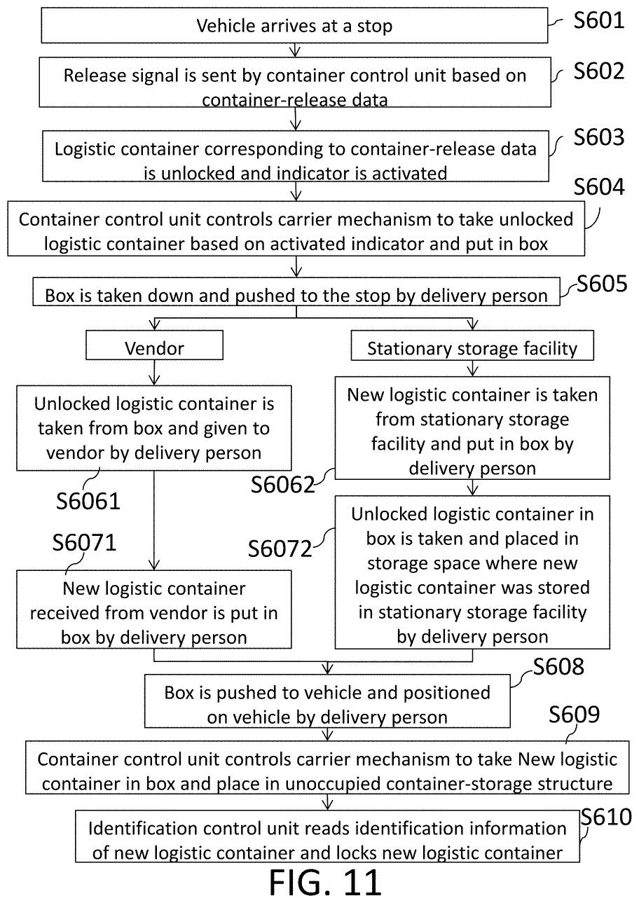

Referring to FIG. 11, which is a pick-up and drop-off process in a smart logistics method according to second embodiment of the present disclosure, step S601 is the vehicle driven by the delivery person arriving at a stop, wherein the stop is a vendor or a stationary storage facility, the present disclosure is not limited thereby. In step S602, the container control unit generates and sends a release signal to the identification control unit of the corresponding container-storage structure according to the container-release data sent by the server. Next, in step S603, after receiving the release signal, the identification control unit unlocks the corresponding logistic container and activates the indicator of the corresponding container-storage structure. The identification and unlocking processes of the corresponding container-storage structure are as aforementioned with reference to FIG. 4, and therefore will not be described herein. Step S604 is the container control unit controlling the carrier mechanism to take the unlocked logistic container and place it into the box. The delivery person knows precisely from the activated indicator whether the carrier mechanism has completed taking all of the logistic containers whose destination is the current stop and in step S605, removes the box containing the unlocked logistic container from the vehicle and pushes the box to the stop.

When the stop is a vendor, the delivery person gives the unlocked logistic container in the box to the vendor as shown in step S6061, and if the vendor has a new logistic container to give to the delivery person, the delivery person puts the new logistic container in the box in step S6071.

When the stop is a stationary storage facility, if the stationary storage facility is full, in other words, there is no storage space for placing more logistic container, the delivery person takes a new logistic container from the stationary storage facility and puts it in the box in step S6062. Subsequently in step S6072, the delivery person places the unlocked logistic container from the box into the storage space where the new logistic container was stored in the stationary facility. However, if the stationary storage facility is not full, then step S6062 is optional and can be skipped, and the delivery person just place the unlocked logistic container from the box into any storage space that is unoccupied by other logistic container in the stationary storage facility.

Once the delivery person finished distributing the unlocked logistic container in the box, the delivery person pushes the box to the vehicle and position the box on the vehicle in step S608. In step S609, the container control unit controls the carrier mechanism to take out the new logistic container from the box and place it into a container-storage structure that is unoccupied by other logistic container in the base device. In step S510, when the new logistic container is placed into the container-storage structure, the identification control unit of the container-storage structure reads the identification information of the logistic container and locks the logistic container in the container-storage structure.

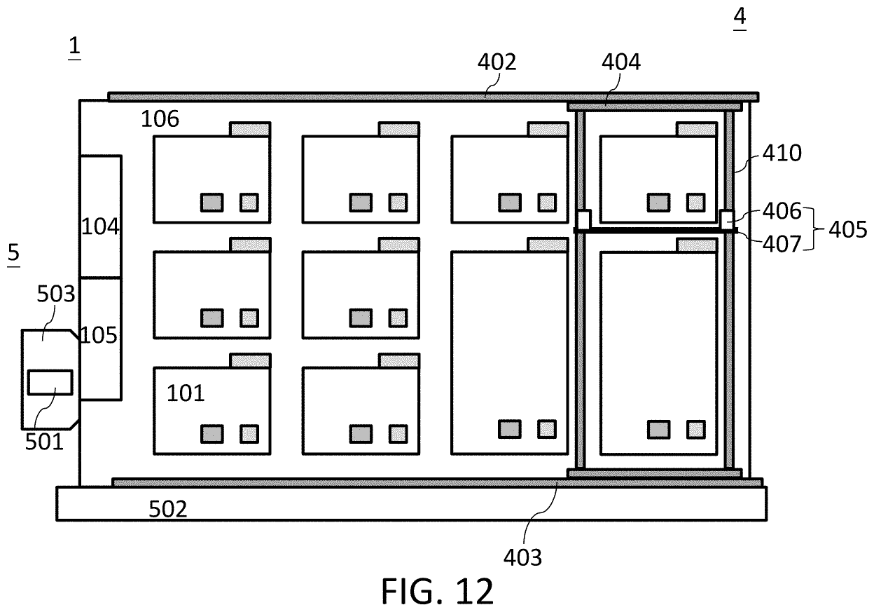

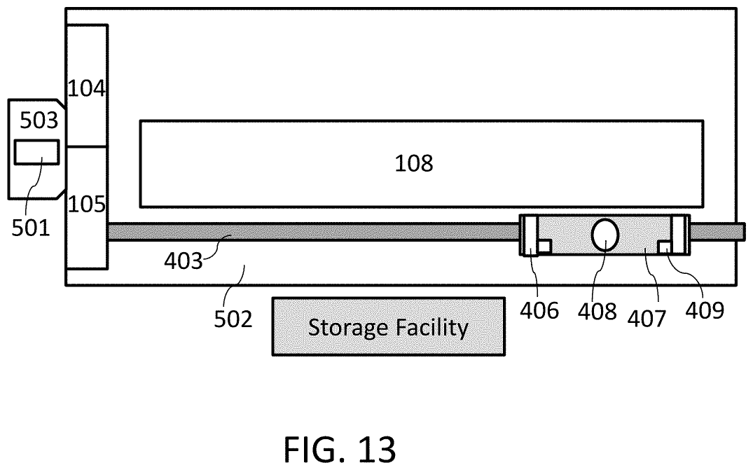

FIG. 12 and FIG. 13 are respectively a side view and a top view of a smart storage equipment for smart logistics system according to third embodiment of the present disclosure that is used for unloading goods automatically. The smart storage equipment of the third embodiment is similar to the aforementioned smart storage equipment in the second embodiment, wherein the difference is that the smart storage equipment for automatic unloading does not have the box 401 disposed in the carrier mechanism 4 and further includes a smart positioning module 409 disposed in the clamping module 405 for identifying a position of the storage space in the stationary storage facility.

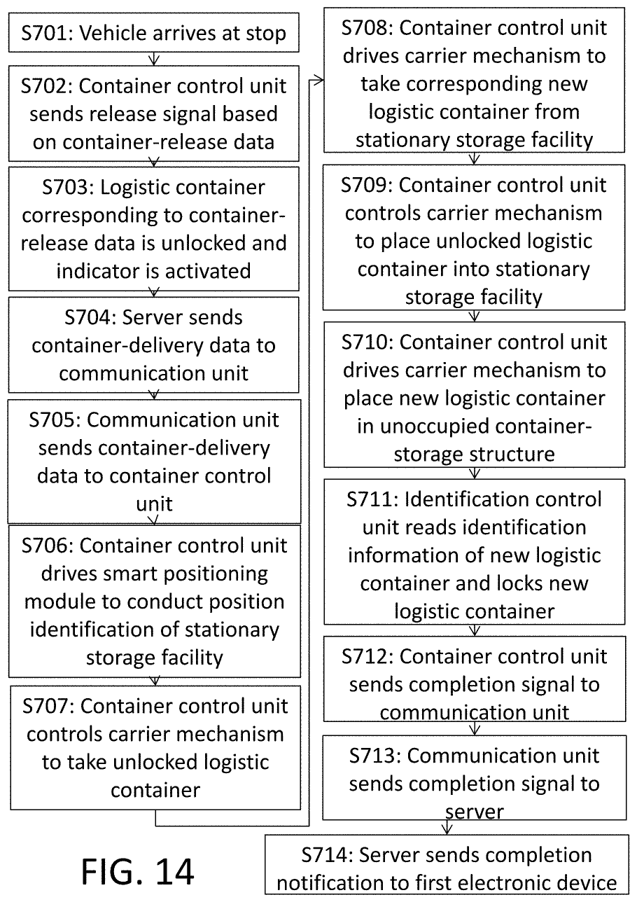

FIG. 14 is a flowchart illustrating a pick-up and drop-off process in a smart logistics method according to third embodiment of the present disclosure. Referring to FIG. 14, the first step S701 is the delivery person arriving at a stop with the vehicle, wherein the stop is a stationary storage facility, or a vendor who is equipped with something similar to the stationary storage facility. In step S702, the container control unit generates and sends a release signal according to a container-release data sent from the server to the identification control unit of the corresponding container-storage structure, and in step S703, the identification control unit which has received the release signal unlocks the corresponding logistic container and activates the indicator of the corresponding container-storage structure. The identification process of the corresponding container-storage structure and the unlocking process are as aforementioned with reference to FIG. 4 and therefore will not be described herein. In step S704, the server sends a container-delivery data to the communication unit, and the communication unit sends the received container-delivery data to the container control unit in step S705. Then, according to the received container-delivery data, the container control unit drives the smart positioning module to conduct position identification of storage facility in step S706. In specific, the container control unit drives the smart positioning module to decipher the container-delivery data so as to know or obtain a location of the logistic container in the stationary storage facility, wherein the container-delivery data includes, but not limited to, identification information and storage location of the logistic container that needs to be taken from the current stationary storage facility, or identification information and storage location of the logistic container that is empty at the current stationary storage facility.

In step S707, the container control unit controls the carrier mechanism to take the unlocked logistic container and in step S708, the container control unit drives the carrier mechanism to take the new logistic container corresponding to the container-delivery data from the stationary storage facility. Next, in step S709, the container control unit controls the carrier mechanism to place the unlocked logistic container in the stationary storage facility and in step S710, the container control unit drives the carrier mechanism to place the new logistic container into a container-storage structure that is unoccupied by other logistic container in the base device. When the control unit controls the carrier mechanism to place the unlocked logistic container in the stationary storage facility, the unlocked logistic container is placed in the storage space where the new logistic container was originally stored in the stationary storage facility, or in any storage space that is unoccupied by other logistic container in the stationary storage facility. Moreover, if there is no unlocked logistic container to be placed, in other words, the current stop is not a destination for the logistic containers on the vehicle, steps S707 and S709 can be skipped. In step S711, when the new logistic container is placed into the container-storage structure, the identification control unit of the container-storage structure reads the identification information of the logistic container and locks the logistic container in the container-storage structure. In addition, if there is no new logistic container to be collected at the current stop, steps S708, S709, and S711 can be skipped.

In one embodiment, the carrier mechanism takes the unlocked logistic container in step S707 and temporarily keeps it on the carrier mechanism, and then takes the new logistic container in step S708 and also temporarily keeps it on the carrier mechanism. Then in steps S709 and S710, the carrier mechanism respectively places the two logistic containers in the stationary storage facility and the container-storage structure of the base device. The present disclosure does not limit the order of steps S708-S710, as long as step S707 is performed before step S709 and step S708 is performed before step S710. For example, in another embodiment, the carrier mechanism conducts steps S708 and S710 first by taking the new logistic container from the stationary storage facility and placing it in a container-storage structure that is unoccupied in the base device, and then conducts steps S707 and S709 by taking the unlocked logistic container from the container-storage structure and placing it in the stationary storage facility.

When the logistic containers corresponding to the container-release data and the container-delivery data are put into new locations, the container control unit sends a completion signal to the communication unit in step S712 and the communication unit sends the completion signal to the server in step S713. As shown in step S714, the server generates and sends a completion notification to the first electronic device after receiving the completion signal, so as to notify the delivery person that the work at the current stop is complete and the delivery person can move forward to the next stop.

Further, the aforementioned stationary storage facility and the smart storage equipment can serve as transfer points for logistics purpose, especially for long-haul logistic operations. When the delivery person transports a logistic container in the smart logistic storage equipment to one of the stationary storage facilities, the logistic container is taken out from the base device and placed in the stationary storage facility. Subsequently, another delivery person arriving at the stationary storage facility takes the logistic container from the stationary storage facility and places it on the base device of his vehicle so as to transport the logistic container to the next stationary storage facility. As such, the smart storage equipment in combination with the plurality of stationary storage facilities act as hubs for temporarily storing as well as transferring logistic containers in long-haul logistic operations, and the logistic container in the stationary storage facility of its final destination is opened by the consumer unlocking a cover lock of the logistic container and therefore the consumer gets the food or merchandise inside of the logistic container.

In view of above, the technical benefits of the smart storage equipment for smart logistics system and the smart logistics method using the smart storage equipment as described by the embodiments of the present disclosure, in comparison to the conventional technology, are described below.

The conventional storage equipment on the delivery vehicle of the logistics system is an undivided space and lacks gadgets to hold the goods in place, and so the goods may be bumped and damaged during transportation. On the contrary, the smart storage equipment for smart logistics system and the smart logistics method using the smart storage equipment of the present disclosure provide an individual storage space and a locking device for each good to ensure the goods do not move during transportation and are prevented from being bumped or damaged. Moreover, in the smart storage equipment for smart logistics system and the smart logistics method using the smart storage equipment of the present disclosure, the container-storage structure includes an indicator which minimizes the chance of the wrong goods being taken by the delivery person and in turn enhances distribution efficiency.

The above disclosure is only the preferred embodiment of the present disclosure, and not used for limiting the scope of the present disclosure. All equivalent variations and modifications on the basis of shapes, structures, features and spirits described in claims of the present disclosure should be included in the claims of the present disclosure.

1. A smart storage equipment for smart logistics system, the smart storage equipment comprising:
a base device, comprising:
a base comprising a plurality of container-storage structures, each of the plurality of container-storage structures comprises a container lock and an identification control unit;
a container control unit disposed in the base and electrically or communicatively connected to the identification control unit; and
a communication unit disposed in the base and communicatively connected to the container control unit and a server; and
at least one logistic container, comprising a container body, wherein the container body comprises an identification information and a base lock corresponding to the container lock;
wherein when the logistic container is placed in the container-storage structure, the identification control unit reads the identification information of the logistic container and enforces a locking between the container lock and the base lock; and
when the logistic container is locked in the container-storage structure, the container control unit controls an unlocking between the container lock and the base lock according to a container-release data in or from the server.

2. The smart storage equipment of claim 1, wherein the container-release data comprises information of logistic containers that need to be unlocked, and based on the container-release data, the container control unit generates and sends a release signal to the identification control unit of the container-storage structure containing the logistic container that needs to be unlocked to control the identification control unit to unlock the locking between the container lock and the base lock.

3. The smart storage equipment of claim 2, wherein the container control unit comprises a control button, the release signal is generated when the control button is touched or pressed by a delivery person, and the logistic container corresponding to the container-release data is unlocked for the delivery person to take out of the base device.

4. The smart storage equipment of claim 3, wherein the base further comprises at least one storage module for disposing the plurality of container-storage structures, the storage module is disposed on the base and is fixed, rotatable or slidable relative to the base.

5. The smart storage equipment of claim 2, further comprising a carrier mechanism movably disposed around a periphery of the base and facing a side of the container-storage structure that stores the logistic container and electrically or communicatively connected to the container control unit, wherein the container control unit controls the carrier mechanism to take the unlocked logistic container according to the container-release data.

6. The smart storage equipment of claim 5, wherein the carrier mechanism comprises a box, the carrier mechanism takes and puts the unlocked logistic container in the box for a delivery person to take, and when a new logistic container is put in the box by the delivery person, the container control unit controls the carrier mechanism to take and place the new logistic container in an unoccupied container-storage structure of the base.

7. The smart storage equipment of claim 5, wherein the container control unit controls the carrier mechanism to place the unlocked logistic container in a stationary storage facility according to a container-delivery data in or from the server.

8. The smart storage equipment of claim 5, wherein the container control unit controls the carrier mechanism to take a new logistic container from a stationary storage facility and place the new logistic container in an unoccupied container-storage structure of the base.

9. The smart storage equipment of claim 2, wherein the container-storage structure further comprises an indicator electrically connected to the identification control unit and the identification control unit activates the indicator based on the release signal for a delivery person to pinpoint the unlocked logistic container.

10. A smart logistics system comprising:
a vehicle; and
a smart storage equipment of claim 1 disposed on the vehicle; and
a server.

11. The smart logistics system of claim 10, wherein the vehicle is a motorcycle, an automobile, a truck, an unmanned flying vehicle, a watercraft, or an airplane.

12. The smart logistics system of claim 10, wherein the smart storage equipment comprises a carrier mechanism electrically or communicatively connected to the container control unit, the carrier mechanism comprises a smart positioning module, and when the vehicle stops by a stationary storage facility, according to a container-delivery data in or from the server, the container control unit drives the smart positioning module of the carrier mechanism to decipher the container-delivery data to know a location of a new logistic container in the stationary storage facility and the container control unit controls the carrier mechanism to take the new logistic container from the stationary storage facility.

13. The smart logistics system of claim 12, wherein the vehicle comprises a first electronic device signally connected to the server, and when the vehicle stops by a stationary storage facility, the container control unit controls the carrier mechanism to place an unlocked logistic container in the stationary storage facility according to a container-delivery data in or from the server and sends a completion signal to the server through the communication unit after the unlocked logistic container is placed in the stationary storage facility, and the server sends a completion notification to the first electronic device.

14. A smart logistics method comprising:
providing a smart storage equipment, wherein the smart storage equipment is installable on a vehicle and comprises:
a base device, comprising:
a base comprising a plurality of container-storage structures, wherein each of the container-storage structures comprises a container lock and an identification control unit;
a container control unit disposed in the base and communicatively or electrically connected to the identification control unit; and
a communication unit disposed in the base and communicatively connected to the container control unit and a server; and
at least one logistic container comprising a container body, wherein the container body comprises an identification information and a base lock corresponding to the container lock;
placing the logistic container in the container-storage structure;
the identification control unit reading the identification information of the logistic container and enforcing a locking between the container lock and the base lock; and
the container control unit controlling an unlocking between the container lock and the base lock according to a container-release data in or from the server.

15. The smart logistics method of claim 14, wherein the container-release data comprises information of logistic containers that need to be unlocked, the controlling-unlocking step comprises, based on the container-release data, the container control unit generating and sending a release signal to the identification control unit of the container-storage structure containing the logistic container that needs to be unlocked and controlling the identification control unit to unlock the locking between the container lock and the base lock.

16. The smart logistics method of claim 15, wherein the smart storage equipment further comprises a carrier mechanism movably disposed around a periphery of the base and facing a side of the container-storage structure storing the logistic container and electrically or communicatively connected to the container control unit, and the smart logistics method further comprises the container control unit controlling the carrier mechanism to take the unlocked logistic container according to the container-release data.

17. The smart logistics method of claim 16, wherein the container control unit controls the carrier mechanism to place the unlocked logistic container in a stationary storage facility according to a container-delivery data in or from the server, or to place the unlocked logistic container in a box of the carrier mechanism for a delivery person to take.

18. The smart logistics method of claim 16, further comprising the container control unit controlling the carrier mechanism to take a new logistic container from a stationary storage facility according to a container-delivery data in or from the server or to take a new logistic container put in a box of the carrier mechanism by a delivery person, and place the new logistic container in an unoccupied container-storage structure of the base.

19. The smart logistics method of claim 15, wherein the container-storage structure further comprises an indicator electrically connected to the identification unit, and the smart logistics method further comprises the identification unit activating the indicator based on the release signal for a delivery person to pinpoint the unlocked logistic container.

20. The smart logistics method of claim 16, wherein the carrier mechanism further comprises a smart positioning module, and the smart logistics method further comprises: when the vehicle stops by a stationary storage facility, according to a container-delivery data in or from a server, the container control unit driving the smart positioning module of the carrier mechanism to decipher the container-delivery data to know a location of a new logistic container in the stationary storage facility and controlling the carrier mechanism to take the new logistic container from the stationary storage facility.
